(19) United States
(12) Patent Application Publication
(10) Pub. No.: US 2008/0231638 A1
(43) Pub. Date: Sep. 25, 2008

(54) SCREEN DISPLAY APPARATUS AND ADJUSTMENT METHOD OF IMAGE APPARATUS

(75) Inventor: Ching-Yueh Chiang, Nantou County (TW)

Correspondence Address: QUINTERO LAW OFFICE, PC, 2210 MAIN STREET, SUITE 200, SANTA MONICA, CA, 90405, US

(73) Assignee: QISDA CORPORATION, Taoyuan County (TW)

(21) Appl. No.: 12/051,796

(22) Filed: Mar. 19, 2008

(30) Foreign Application Priority Data
Mar. 22, 2007 (TW) TW96109870

(51) Int. Cl. G09G 5/00

(52) U.S. Cl. 345/581

(57) ABSTRACT

A screen display apparatus is provided. A first display device has a first display module. A screen adjustment device is coupled to the first display device through a transmission line, and comprises a user interface adjusting a display setting value of the first display module, and a memory device storing a display parameter corresponding to the display setting value.

### BACKGROUND OF THE INVENTION

1. Field of the Invention

The invention relates to a screen display apparatus, and more particularly, to a screen display apparatus with a screen adjustment device.

2. Description of the Related Art

In present application of displays, users can adjust settings and parameters of a screen on the display through an on screen display (OSD) function. For the OSD function, users can directly observe the setting and adjustment status of a display on the screen of the display, to easily adjust an image display setting of the display by an adjustment interface on the display.

For typical liquid crystal displays (LCD), such as a monitor, the OSD function comprises setting brightness, contrast and each color component of RGB (red, green and blue) settings. However, the typical display is unable to provide additional display color adjustments due to limitations of whole display effect.

In application of color printing and advertising output and so on, a professional user requires that images and output displayed on a screen are accurate and unified. For this reason, a high level display is often used to achieve accurate and unified colors. The high level display has complex and sophisticated setting items, and can obtain a color performance photographically, such as brightness, sharpness, mode, Gamma, color temperature, and hue and saturation of RGBCMY (red, green, blue, cyan, magenta and yellow) etc. For certain instances, users need to calibrate a multitude of high level displays so that all displays have the same display setting value in order to achieve an identical color performance. In general, users execute three steps to achieve the identical color performance. The three steps comprise setting a display setting value of a first display to achieve an optimum color performance, adjusting features (ex. brightness and contrast and so on) of other displays to equal to that of the first display, and fine tuning the color performance of other displays to achieve the identical color performance of the first display. However, the OSD setting items for a high level display are very complex and various, thus requireing a user to spend a enormous amount of time to manually adjust several high level displays to have the same setting values.

### BRIEF SUMMARY OF THE INVENTION

The invention discloses a screen display apparatus comprising a first display device comprising a first display module, and a screen adjustment device coupled to the first display device through a transmission line. The screen adjustment device comprises a user interface for adjusting a display setting value of the first display module, and a first memory device for storing a display parameter corresponding to the display setting value.

Furthermore, the invention discloses a screen display apparatus comprising a first display device and a screen adjustment device. The first display device comprises a first display module having a display setting value and a first wireless device for receiving and transmitting a display parameter corresponding to the display setting value. The screen adjustment device comprises a second wireless device for receiving and transmitting the display parameter, and a first memory device for storing the display parameter.

Moreover, the invention discloses an adjustment method for an image apparatus, comprising coupling a screen adjustment device with a first display device, adjusting a display setting value of the first display device through a user interface of the screen adjustment device, storing a display parameter corresponding to the display setting value to a memory device of the screen adjustment device, coupling the screen adjustment device with a second display device, and adjusting the second display device according to the display parameter stored in the memory device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a screen display apparatus according to an embodiment of the invention;

FIG. 2 shows a screen display apparatus according to another embodiment of the invention;

FIG. 3 shows a screen display apparatus according to another embodiment of the invention; and

FIG. 4 shows an adjustment method of image apparatus according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

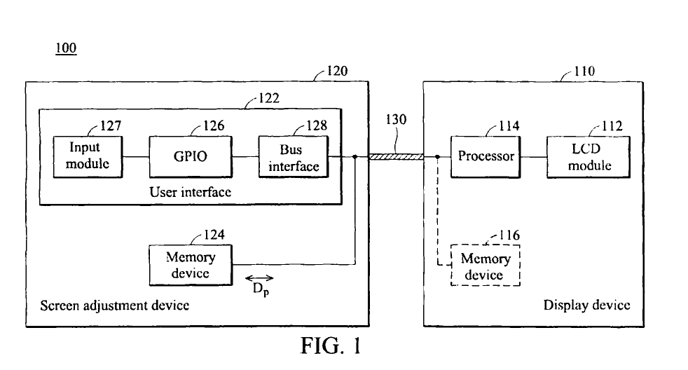

FIG. 1 shows a screen display apparatus 100 according to an embodiment of the invention. The screen display apparatus 100 comprises a display device 110, a screen adjustment device 120 and a transmission line 130. The transmission line 130 is an Inter Integrated Circuit (I²C) bus and is coupled between the display device 110 and the screen adjustment device 120. The display device 110 comprises an LCD module 112 and a processor 114. The screen adjustment device 120 comprises a user interface 122 and a memory device 124, wherein the memory device 124 may be an electrically erasable programmable read only memory (EEPROM). The user interface 122 comprises a general purpose I/O (GPIO) 126, an input module 127 and a bus interface 128, wherein input module 127 comprises keypads, keyboard or knobs etc. In addition, the memory device described in the invention is compatible with the transmission line 130.

In FIG. 1, users can use the user interface 122 to adjust a display setting value of the LCD module 112 for the display device 110. The GPIO 126 transmits a status of the input module 127, which is operated by users, to the processor 114 through the bus interface 128 and the transmission line 130. Then, the processor 114 adjusts the display setting value of the LCD module 112 according to the received input status. After the adjustment of the display setting value is completed and the optimum color performance is achieved, the processor 114 stores a display parameter Dₚ corresponding to the display setting value of the LCD module 112 to the memory device 124 through the transmission line 130. The display device 110 also comprises a memory device 116 for storing the display parameter Dₚ, wherein the memory device 116 may be an EEPROM.

After the setting of the display device 110 is completed, a user can couple the screen adjustment device 120 to other display devices which are substantially equal to the display device 110 through the transmission line 130, respectively. Then, each processor of the other display devices would receive the display parameter Dₚ stored in the memory device 124 through the transmission line 130 and adjust a display setting value of an LCD module within the other display device according to the display parameter Dₚ. Therefore, in this embodiment, the screen adjustment device 120 and the transmission line 130 are used to copy and transmit the display parameter Dₚ to other display devices easily and quickly. The function reduces adjustment time for each LCD module and achieves the same color performance.

In another embodiment of the invention, the transmission line 130 may also be other types of bus, such as recommended standard 232 (RS232) or Address/Data Bus (A/D bus) and so on. Furthermore, the screen adjustment device 120 also comprises a processor.

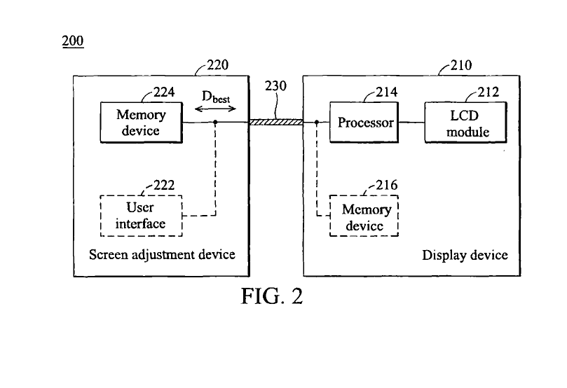

FIG. 2 shows a screen display apparatus 200 according to another embodiment of the invention. The screen display apparatus 200 comprises a display device 210, a screen adjustment device 220 and a transmission line 230 coupled between the display device 210 and the screen adjustment device 220. The display device 210 comprises an LCD module 212 and a processor 214, and the screen adjustment device 220 comprises a memory device 224. The transmission line 230 is an I²C bus and the memory device 224 is an EEPROM. The LCD module 212 has a pre-adjusted display setting value. Users can utilize the screen adjustment device 220 to transmit a display parameter D_{best}, corresponding to the pre-adjusted setting value, to other display devices which are substantially equal to the display device 210.

First, the LCD module 212 of the display device 210 is adjusted with a direct adjusting manner or the adjusting manner described in FIG. 1. The processor 214 then stores the display parameter D_{best} to the memory device 224 through the transmission line 230. When the screen adjustment device 220 is coupled to another display device by a user, a processor of another display device would receive the display parameter D_{best} stored in the memory device 224 through the transmission line 230, and adjust an LCD module within the other display device according to the display parameter D_{best}. Moreover, the display device 210 may also comprise a memory device 216 for storing the display parameter D_{best}. The screen adjustment device 220 may also comprise a user interface 222 to adjust a display setting value of the LCD module 212 or each display module within other display devices.

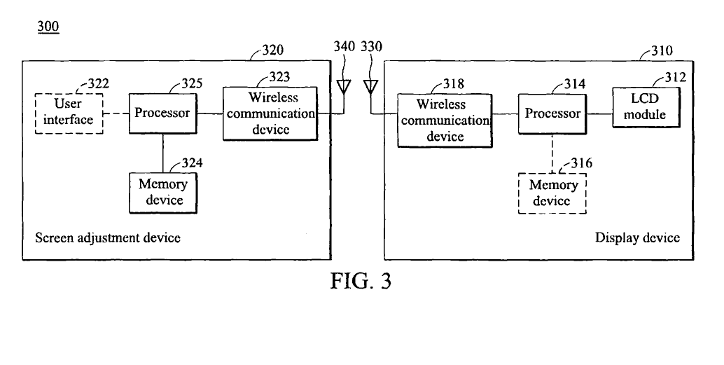

FIG. 3 shows a screen display apparatus 300 according to another embodiment of the invention. The screen display apparatus 300 comprises a display device 310, a screen adjustment device 320 and antennas 330 and 340. The display device 310 comprises an LCD module 312, a processor 314 and a wireless communication device 318. The screen adjustment device 320 comprises a wireless communication device 323, a memory device 324 and a processor 325. Transmitting and receiving of the wireless communication device 318 and the wireless communication device 323 are controlled by the processors 314 and 325, respectively. The memory device 324 is an EEPROM. A wireless device composed of the wireless communication device and the antenna (i.e. the wireless communication device 318 and the antenna 330, and the wireless communication device 323 and the antenna 340) may be a blue tooth device, infrared ray device or other wireless transmission device. The screen adjustment device 320 may also comprise a user interface 322 to adjust a display setting value of the LCD module 312 according to a user's setting. Furthermore, the display device 310 may also comprise a memory device 316 to store a display parameter.

As described above, users can store the display parameter of the display device 310 to the memory device 324 by the wireless transmission manner described in FIG. 3. Then, user would utilize the screen adjustment device 320 to transmit the display parameter to other devices which are substantially equal to the display device 310, and adjusts each LCD module of other devices according to the transmitted display parameters.

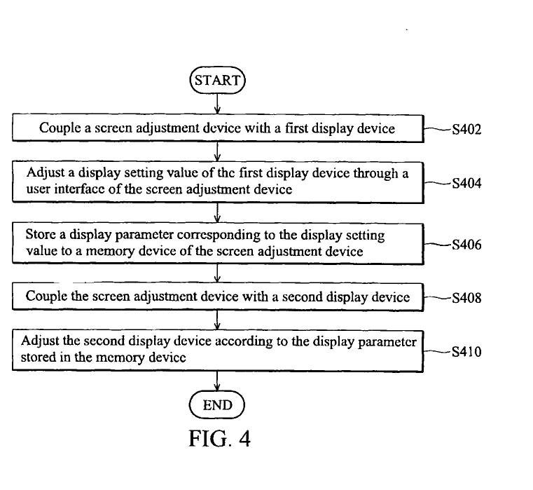

FIG. 4 shows an adjustment method of image apparatus according to an embodiment of the invention. First, the user connects a screen adjustment device to a first display device in step S402. In step S404, the user can adjust a display setting value of the first display device through a user interface of the screen adjustment device. Then, a display parameter corresponding to the display setting value is stored to a memory device of the screen adjustment device in step S406. The user then connects the screen adjustment device to a second display device in step S408. Finally, in step S410, the user can adjust the second display device according to the display parameter stored in the memory device. Moreover, a wire or wireless manner is implemented in both the step S402 and S408.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A screen display apparatus, comprising:
a first display device comprising a first display module; and
a screen adjustment device coupled to the first display device through a transmission line, comprising:
a user interface for adjusting a display setting value of the first display module; and
a first memory device for storing a display parameter corresponding to the display setting value.

2. The screen display apparatus as claimed in claim 1, wherein the screen adjustment device is disposed outside the first display device.

3. The screen display apparatus as claimed in claim 1, wherein the first display device further comprises a first processor for storing the display parameter corresponding to the display setting value to the first memory device through the transmission line.

4. The screen display apparatus as claimed in claim 1, further comprising a second display device having a second display module and a second processor.

5. The screen display apparatus as claimed in claim 4, wherein the second processor receives the display parameter stored in the first memory device through the transmission line, and adjusts the second display module according to the display parameter.

6. The screen display apparatus as claimed in claim 1, wherein the user interface comprises an input module, a GPIO and a bus interface.

7. The screen display apparatus as claimed in claim 1, wherein the first memory device is an EEPROM.

8. The screen display apparatus as claimed in claim 1, wherein the transmission line is an I²C bus.

9. The screen display apparatus as claimed in claim 1, wherein the first display device further comprises a second memory device for storing the display parameter.

10. The screen display apparatus as claimed in claim 9, wherein the second memory device is an EEPROM.

11. A screen display apparatus, comprising:
a first display device comprising:
a first display module having a display setting value; and
a first wireless device for selectively receiving and transmitting a display parameter corresponding to the display setting value; and
a screen adjustment device comprising:
a second wireless device for selectively receiving and transmitting the display parameter; and
a first memory device for storing the display parameter.

12. The screen display apparatus as claimed in claim 11, wherein the first display device further comprises a first processor for controlling the first wireless device to selectively receive and transmit the display parameter, and the screen adjustment device further comprises a second processor for controlling the second wireless device to selectively receive and transmit the display parameter.

13. The screen display apparatus as claimed in claim 12, wherein the second processor controls the second wireless device to receive the display parameter from the first wireless device, and the second processor stores the display parameter to the first memory device.

14. The screen display apparatus as claimed in claim 12, wherein the screen adjustment device further comprises a user interface.

15. The screen display apparatus as claimed in claim 14, wherein the first processor receives a user setting of the user interface from the second wireless device through the first wireless device, and adjusts the display setting value of the first display module according to the user setting.

16. The screen display apparatus as claimed in claim 11, the first memory device is an EEPROM.

17. The screen display apparatus as claimed in claim 11, further comprising a second display module having a second display module, a third wireless device and a third processor.

18. The screen display apparatus as claimed in claim 17, wherein the third processor receives the display parameter stored in the first memory device through the third wireless device, and adjusts the second display module according to the display parameter.

19. The screen display apparatus as claimed in claim 11, wherein the first display device further comprises a second memory device for storing the display parameter.

20. An adjustment method for an image apparatus, comprising:
coupling a screen adjustment device with a first display device;
adjusting a display setting value of the first display device through a user interface of the screen adjustment device;
storing a display parameter corresponding to the display setting value to a memory device of the screen adjustment device;
coupling the screen adjustment device with a second display device; and
adjusting the second display device according to the display parameter stored in the memory device.

21. The adjustment method as claimed in claim 20, wherein the steps of coupling the screen adjustment device with the first display device and the second display device are implemented with one of a wire and wireless manner.
